(19) United States
(12) Patent Application Publication
(10) Pub. No.: US 2025/0168938 A1
(43) Pub. Date: May 22, 2025

(54) WAX MELTING APPARATUS AND RELATED SYSTEMS AND METHODS

(71) Applicant: Nhi Pham Enterprise, LLC, Houston, TX (US)

(72) Inventor: Danh Cong Pham, Houston, TX (US)

(73) Assignee: Nhi Pham Enterprise, LLC, Houston, TX (US)

(21) Appl. No.: 18/956,192

(22) Filed: Nov. 22, 2024

Related U.S. Application Data
(60) Provisional application No. 63/602,369, filed on Nov. 22, 2023.

(51) Int. Cl. H05B 3/80

(52) U.S. Cl. CPC H05B 3/80

(57) ABSTRACT

Wax melting devices and methods are disclosed for removed hardened paraffin wax from a bulk container. A wax melting apparatus may include a melting container supported between two support members. The melting container may have an upper locked position. A bulk container contained hardened wax may be positioned beneath the melting container. The melting container may be partially filled with a liquid. A heater element may be submerged in the liquid and energized to heat the liquid. The melting container containing heated water is released from its upper locked position and lowered downwardly until resting on top of hardened wax in a bulk container. Heat from the melting container melts the wax. As the wax melts, the melting container slowing sinks downwardly into the bulk container until all of the hardened wax in the bulk container is melted.

### RELATED APPLICATIONS

This application claims the benefit of U.S. Provisional Application No. 63/602,369, filed Nov. 22, 2023, the contents of which are fully incorporated herein by reference.

### BACKGROUND OF THE INVENTIONS

### 1. Field of the Inventions

The present inventions generally pertain to paraffin wax, and more particularly to methods and systems for removing hardened paraffin wax from a container.

### 2. Description of the Related Art

It is known that paraffin wax is used in beauty salons for cosmetic purposes to treat a person's skin. The paraffin wax is typically packaged in hand-held plastic packages that are delivered to the salon for use. The packaged paraffin wax is in a solid form, much like the consistency of a candle. When the paraffin wax is needed, the salon will cut off the plastic packaging, and then place the wax into a warmer where it is warmed into a liquid-like or flowable consistency. The wax can then be easily dipped out of the warmer and applied to the customer's skin in a known manner.

It has been determined that it would be more efficient and economical to deliver the paraffin wax to beauty salons in larger, bulk containers, such as a container around the size of a five-gallon bucket, for example. Proceeding in this fashion, however, creates a problem to be solved, namely, how to extract the hardened paraffin wax from the bulk container. The present inventions as discussed hereinbelow have been developed to address and solve this problem.

### SUMMARY OF THE INVENTIONS

In one aspect of the present inventions, paraffin wax is poured into an empty bulk container and then allowed to harden. To remove the paraffin wax, it is melted in the bulk container so it can be removed in liquid or flowable form. In one aspect, to melt the wax, a frame is positioned around the wax container to hold an open container filled with water that is positioned on top of the hardened wax and then a heating element is placed in the water to heat the water. This heats up the water container which then heats up and melts the wax. As the wax melts, the heated container full of hot water gradually sinks down into the container of wax (with the container of hot water being supported and guided by the frame) until the container of hot water reaches near the bottom of the wax container and all of the wax has been melted. The melted wax can be dipped out for use.

In another aspect, the present inventions may include a wax melting apparatus comprising: a lower support base; a left vertical support connected to the lower support base and extending upwardly therefrom; a right vertical support connected to the lower support base and extending upwardly therefrom; a melting container connected between the left vertical support and the right vertical support, the melting container being movable between an upper locked position and a lowermost position; and a heating element positioned within the melting container. Another feature of this aspect of the present inventions may be that each of the left vertical support and the right vertical support has an upper locked position corresponding to the upper locked position of the melting container and a lowermost position corresponding to the lowermost position of the melting container. Another feature of this aspect of the present inventions may be that the left vertical support includes a left lower section and a left upper section, the left upper section being disposed for releasable slidable movement within the left lower section; and the right vertical support includes a right lower section and a right upper section, the right upper section being disposed for releasable slidable movement within the right lower section. Another feature of this aspect of the present inventions may be that the left vertical support further includes a left handle having a left release button; and the right vertical support further includes a right handle having a right release button. Another feature of this aspect of the present inventions may be that the left release button has a locked position and a depressed position, the left upper section being locked to the left lower section when the left release button is in its locked position, and the left upper section being free to move within the left lower section when the left release button is in its depressed position; and the right release button has a locked position and a depressed position, the right upper section being locked to the right lower section when the right release button is in its locked position, and the right upper section being free to move within the right lower section when the right release button is in its depressed position. Another feature of this aspect of the present inventions may be that an upper end of the left lower section includes a left release pin adapted for releasable engagement with a lower end of the left upper section, the left release pin being adapted to release engagement between the left upper section and the left lower section in response to movement of the left release button from its locked position to its depressed position; and an upper end of the right lower section includes a right release pin adapted for releasable engagement with a lower end of the right upper section, the right release pin being adapted to release engagement between the right upper section and the right lower section in response to movement of the right release button from its locked position to its depressed position. Another feature of this aspect of the present inventions may be that a lower end of the left lower section included a left lower stop pin, and a lower end of the left upper section being engaged with the left lower stop pin when the left vertical support is in its lowermost position; and a lower end of the right lower section included a right lower stop pin, and a lower end of the right upper section being engaged with the right lower stop pin when the right vertical support is in its lowermost position. Another feature of this aspect of the present inventions may be that the apparatus may further include a bulk container containing hardened wax positioned between the left vertical support and the right vertical support and beneath the melting container when the melting container is in it upper locked position, the lower end of the melting container resting on an upper surface of the hardened wax in the bulk container after the melting container is released from its upper locked position. Another feature of this aspect of the present inventions may be that the apparatus may further include a lid engaged with an upper end of the bulk container, the lid having an opening, the melting container being positioned through the opening when the melting container is resting on the upper surface of the hardened wax. Another feature of this aspect of the present inventions may be that a shape of a lower end of the melting container is one of a pyramid, a flat end, and a triangular prism.

In another aspect, the present inventions may include a wax melting apparatus comprising: a lower support base; a left vertical support connected to the lower support base and extending upwardly therefrom, the left vertical support including a left lower section and a left upper section, the left upper section being disposed for releasable slidable movement within the left lower section, the left upper section having an upper locked position and a lowermost position; a right vertical support connected to the lower support base and extending upwardly therefrom, the right vertical support including a right lower section and a right upper section, the right upper section being disposed for releasable slidable movement within the right lower section, the right upper section having an upper locked position and a lowermost position; a melting container connected between the left vertical support and the right vertical support, the melting container being movable between an upper locked position and a lowermost position, the upper locked position of the melting container corresponding to the upper locked position of the left upper section and to the upper locked position of the right upper section, the lowermost position of the melting container corresponding to the lowermost position of the left upper section and to the lowermost position of the right upper section; and a heating element positioned within the melting container. Another feature of this aspect of the present inventions may be that the left vertical support further includes a left handle having a left release button, the left release button having a locked position and a depressed position, the left upper section being locked to the left lower section when the left release button is in its locked position, and the left upper section being free to move within the left lower section when the left release button is in its depressed position; and the right vertical support further includes a right handle having a right release button, the right release button having a locked position and a depressed position, the right upper section being locked to the right lower section when the right release button is in its locked position, and the right upper section being free to move within the right lower section when the right release button is in its depressed position. Another feature of this aspect of the present inventions may be that an upper end of the left lower section includes a left release pin adapted for releasable engagement with a lower end of the left upper section, the left release pin being adapted to release engagement between the left upper section and the left lower section in response to movement of the left release button from its locked position to its depressed position; and an upper end of the right lower section includes a right release pin adapted for releasable engagement with a lower end of the right upper section, the right release pin being adapted to release engagement between the right upper section and the right lower section in response to movement of the right release button from its locked position to its depressed position. Another feature of this aspect of the present inventions may be that a lower end of the left lower section included a left lower stop pin, and a lower end of the left upper section being engaged with the left lower stop pin when the left vertical support is in its lowermost position; and a lower end of the right lower section included a right lower stop pin, and a lower end of the right upper section being engaged with the right lower stop pin when the right vertical support is in its lowermost position. Another feature of this aspect of the present inventions may be that the apparatus may further include a bulk container containing hardened wax positioned between the left vertical support and the right vertical support and beneath the melting container when the melting container is in it upper locked position, the lower end of the melting container resting on an upper surface of the hardened wax in the bulk container after the melting container is released from its upper locked position. Another feature of this aspect of the present inventions may be that the apparatus may further include a lid engaged with an upper end of the bulk container, the lid having an opening, the melting container being positioned through the opening when the melting container is resting on the upper surface of the hardened wax.

In yet another aspect, the present inventions may include a method of removing hardened wax from a container comprising: providing a melting container; partially filling the melting container with a liquid; positioning the melting container above a bulk container of hardened wax; heating the liquid; and lowering the melting container until a lower end of the melting container contacts an upper surface of the hardened paraffin wax. Another feature of this aspect of the present inventions may be that the method may further include allowing the melting container to lower down into the bulk container as the wax is melted. Another feature of this aspect of the present inventions may be that the method may further include stopping the container before it comes into contact with a lower surface of the bulk container. Another feature of this aspect of the present inventions may be that the method may further include energizing a heater submerged in the liquid inside the melting container to heat the liquid.

Other features, aspects and advantages of the present inventions will become apparent from the following discussion and detailed description.

### BRIEF DESCRIPTION OF THE DRAWINGS

FIG. 1 is a perspective view of a specific embodiment of a wax melting apparatus constructed in accordance with one aspect of the present inventions, and with a melting container shown in an upper, locked position.

FIG. 2 is a perspective view of the wax melting apparatus shown in FIG. 1, only here it is shown with the melting container in a lowered start position, with the bottom of the melting container resting on top of hardened paraffin wax in a bulk container.

FIG. 3 is a perspective view of the wax melting apparatus shown in FIGS. 1 and 2, only here it is shown with the melting container in a further lowered position with a lower section of the melting container disposed in the portion of the paraffin wax that has been melted.

FIG. 4 is atop view of a specific embodiment of a heating element that may form part of the wax melting apparatus shown in FIGS. 1-3.

FIG. 5 is atop view of a specific embodiment of a controller that may be part of the heating element shown in FIG. 4.

FIG. 6 is a perspective view of a lid that is adapted to engage with an upper end of a container of hardened paraffin wax, the lid having a hinged door shown in a closed position.

FIG. 7 is a front view corresponding to the perspective view of the wax melting apparatus as shown in FIG. 1, and further showing the heating element from FIG. 4 in dashed lines.

FIG. 8 is a front view corresponding to the perspective view of the wax melting apparatus as shown in FIG. 2, and further showing the lower end of the melting container resting on top of the upper surface of the hardened paraffin wax in the bulk container.

FIG. 9 is a front view corresponding to the perspective view of the wax melting apparatus as shown in FIG. 3, and further showing the lower portion of the melting container lowered into melted paraffin wax in the bulk container, with the lower end of the melting container in a bottom position spaced apart from a lower surface of the melting container.

FIG. 10 is a perspective view of a melting container in accordance with a specific embodiment of the present inventions, wherein a lower end of the melting container is in the shape of an inverted pyramid.

FIG. 11 is a is a perspective view of a melting container in accordance with a specific embodiment of the present inventions, wherein a lower end of the melting container is in the shape of a triangular prism.

FIG. 12 is a perspective view of a melting container in accordance with a specific embodiment of the present inventions, wherein a lower end of the melting container is a flat surface.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

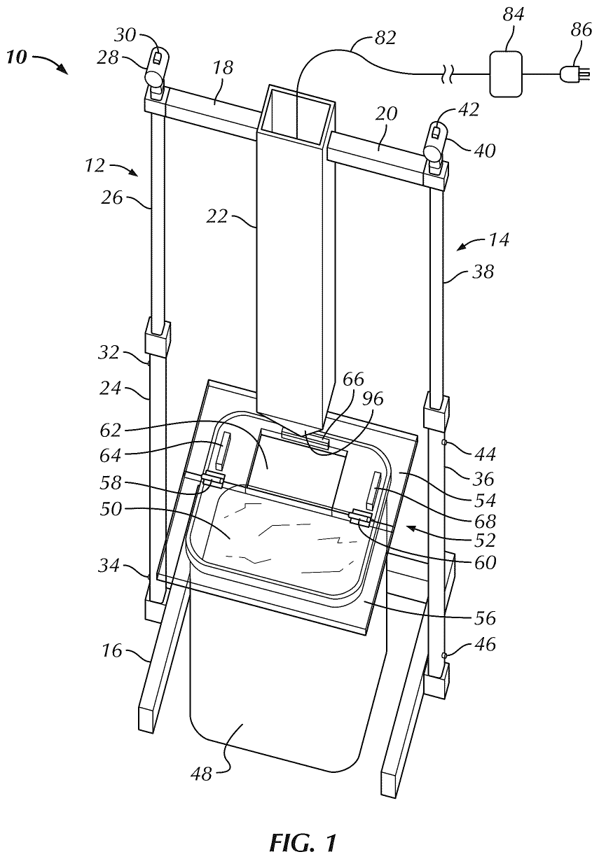

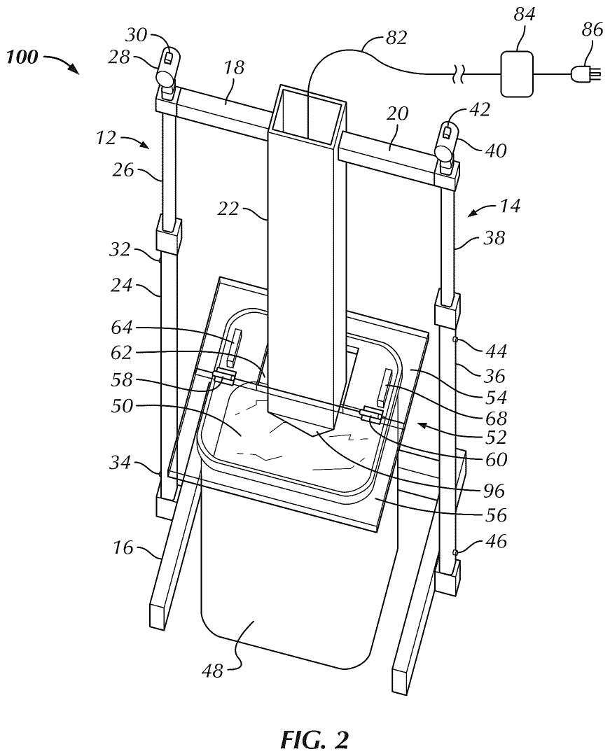

Referring to the drawings in detail, wherein like numerals denote identical elements throughout the several views, and referring initially to FIG. 1, there is shown a perspective view of a specific embodiment of a wax melting apparatus 10 having a left vertical support 12, a right vertical support 14, a lower support base 16, an left upper support arm 18, a right upper support arm 20, and a melting container 22. The wax melting apparatus 10 is shown in an upper locked position in FIG. 1. In a specific embodiment, the left vertical support 12 and the right vertical support 14 may function like releasable telescoping handles commonly used on rolling luggage. In a specific embodiment, the left vertical support 12 may be connected to and extend upwardly from the lower support base 16. In a specific embodiment, the right vertical support 14 may be connected to and extend upwardly from the lower support base 16. In a specific embodiment, the left vertical support 12 and the right vertical support 14 may each be disposed in generally perpendicular relationship to the lower support base 16. In a specific embodiment, the left vertical support 12 and the right vertical support 14 may be spaced apart from each other and disposed in generally parallel relationship to each other.

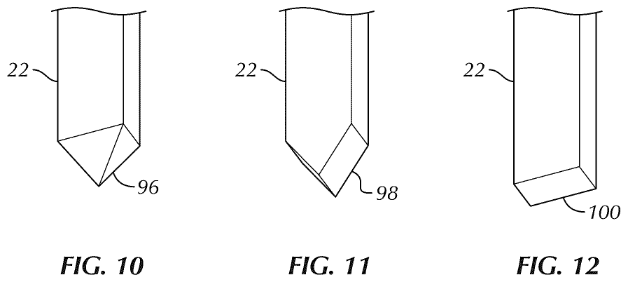

The lower end of the melting container 22 may be provided in a variety of shapes. In a specific embodiment, as shown in FIGS. 1 and 10, the lower end of melting container 22 may be in the shape of a pyramid 96, and terminate at its lowermost end in a point. In another embodiment, as shown in FIG. 11, the lower end of the melting container 22 may be in the shape of a triangular prism 98, like an inverted roof. In another specific embodiment, as shown in FIG. 12, the lower end of the melting container 22 may be an enclosed flat end surface 100. The lower end of the melting container 22 is not limited to any particular shape.

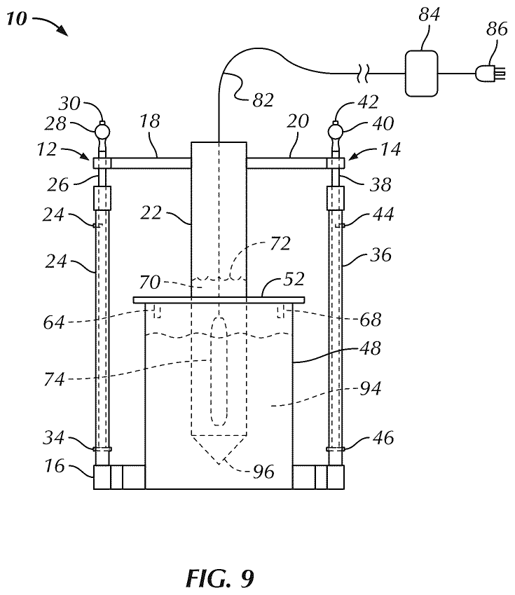

In a specific embodiment, the left vertical support 12 may include a left lower section 24, a left upper section 26, and a left handle 28 having a left release button 30. In a specific embodiment, the left upper section 26 may be disposed for slidable telescoping movement within the left lower section 24. In a specific embodiment, an upper end of the left lower section 24 may include a left release pin 32 adapted for releasable engagement with a lower end of the left upper section 26 in response to depressing the left release button 30 on the left handle 28. A lower end of the left lower section 24 may include a left lower stop pin 34. When the left upper section 26 is lowered down inside the left lower section 24, a lower end of the left upper section 26 will come into contact with and rest against the left lower stop pin 34 when the left vertical support 12 is in a lower position, as shown in FIG. 9. This lower position corresponds with the lower position of the melting container 22, as discussed in more detail below.

In a specific embodiment, the right vertical support 14 may include a right lower right section 36, a right upper section 38, and a right handle 40 having a right release button 42. In a specific embodiment, the right upper section 38 may be disposed for slidable telescoping movement within the right lower section 36. In a specific embodiment, an upper end of the right lower section 36 may include a right release pin 44 adapted for releasable engagement with a lower end of the right upper section 38 in response to depressing the right release button 42 on the right handle 40. A lower end of the right lower section 36 may include a right lower stop pin 46. When the right upper section 38 is lowered down inside the right lower section 36, a lower end of the right upper section 38 will come into contact with and rest against the right lower stop pin 46 when the right vertical support 14 is in a lower position, as shown in FIG. 9. This lower position corresponds with the lower position of the melting container 22, as discussed in more detail below.

In a specific embodiment, the left upper support arm 18 may be connected between an upper end of the left upper section 26 (such as adjacent the left handle 28) and a left side of an upper end of the melting container 22; and the right upper support arm 20 may be connected between an upper end of the right upper section 38 (such as adjacent the right handle 40) and a right side of the upper end of the melting container 22. In a specific embodiment, the left upper support arm 18 and the right upper support arm 20 may be generally horizontal and/or disposed in generally perpendicular relationship to sidewalls of the melting container 22 and/or to the left vertical support 12 and right vertical support 14, respectively.

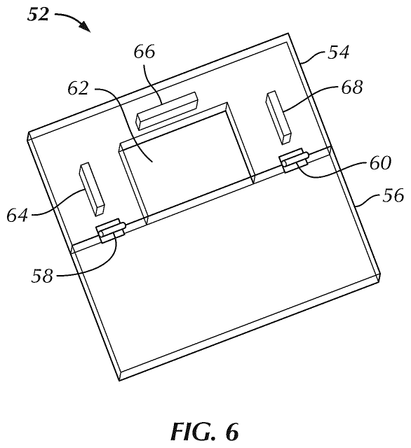

In a specific embodiment, the lower support base 16 may include left and right support members that are spaced apart to form an opening for receiving a bulk container 48 containing hardened paraffin wax 50. In a specific embodiment, the bulk container 48 may have a generally rectangular shape. In a specific embodiment, the bulk container 48 may include a lid 52, which is also shown in FIG. 6. In a specific embodiment, the lid 52 may include a rear support section 54 and a front door 56 that may be hingedly attached to the rear support section 54, such as with hinges 58 and 60. The rear support section 54 may include an opening 62 through which the melting container 22 may be lowered down inside the bulk container 48. In a specific embodiment, the opening 62 may be generally rectangular in shape. In a specific embodiment, the opening 62 may generally conform to the cross-sectional shape of the melting container 22, and may also be slightly larger than the outside surface of the melting container 22. The rear support section 54 may include a left guide member 64, a rear guide member 66, and a right guide member 68, each of which may be connected to a lower surface of the rear support section 54 and may extending downwardly therefrom, and may function to position the lid 52 in engaged alignment with the bulk container 48. In a specific embodiment, the lid 52 may be made from a transparent material (e.g., plexiglass) to allow visibility into the inside of the bulk container 48 to monitor the progress of melting the hardened paraffin wax 50 inside the bulk container 48.

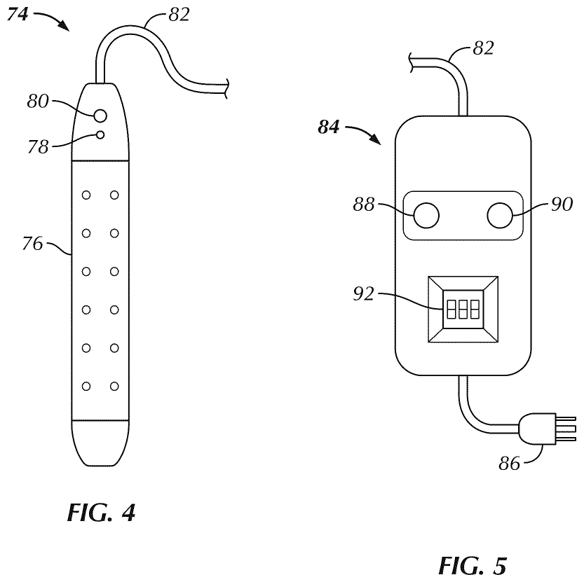

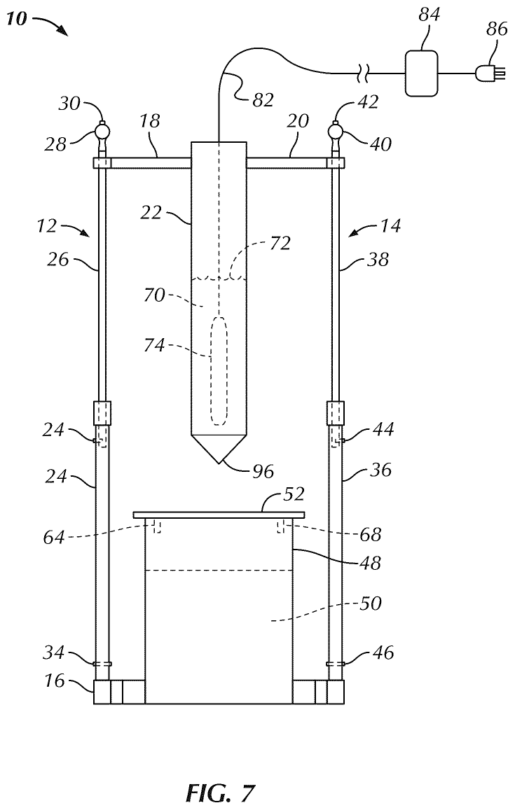

With reference to FIG. 7, it can be seen that the melting container 22 is partially filled with a liquid 72 (e.g., water) up to a water level or fill line 72. In a specific embodiment, the wax melting apparatus 10 may also include a heating element 74 submerged within the liquid 72. Referring to FIGS. 4 and 5, the heating element 74 may include a heating section 76, a water sensor 78 and a thermometer 80. If the water sensor 78 does not sense water, that tells the heating element 74 it is not submerged in water and therefore the heating element 74 will not turn on. The heating element 74 has a power cord 82 with a controller 84 connected to the cord 82 between the heating element 74 and the plug 86 on the end of the cord 82. The controller 84 may include an On/Off button 88, a selector button 90, and a LED readout 92. In a specific embodiment, the heating element 74 and controller 84 may be an “Adjustable Thermostat Immersion Water Heater” available at the HAIYEATBNB™ store on Amazon.com®.

The manner of use and operation of the wax melting apparatus 10 will now be explained. Paraffin wax will be delivered to beauty salons in bulk containers 48. When a beauty salon worker needs to extract paraffin wax from a bulk container 48, the worker will first make sure that the wax melting apparatus 10 is positioned with the melting container 22 in its upper, locked position, as shown in FIGS. 1 and 7. Any shipping lid (not shown) on the bulk container 48 will be removed and the bulk container 48 will be positioned directly below the melting container 22. The top of the bulk container 48 may optionally be covered with the lid 52 and the opening 62 in the lid 52 is positioned directly below and in alignment with the melting container 22. The worker will check to make sure the melting container 22 is filled with water up to the fill line 72 and the heating element 74 is fully submerged in water, as shown in FIG. 7. The worker will then press the On/Off button 88 on the controller 84 to turn the heating element 74 on. The worker will use the selector button 90 to set the heating element 74 to the desired temperature as displayed on the LED readout 92. In a specific embodiment, the water may be heated to a temperature in the range from 110 degrees Fahrenheit to 190 degrees Fahrenheit.

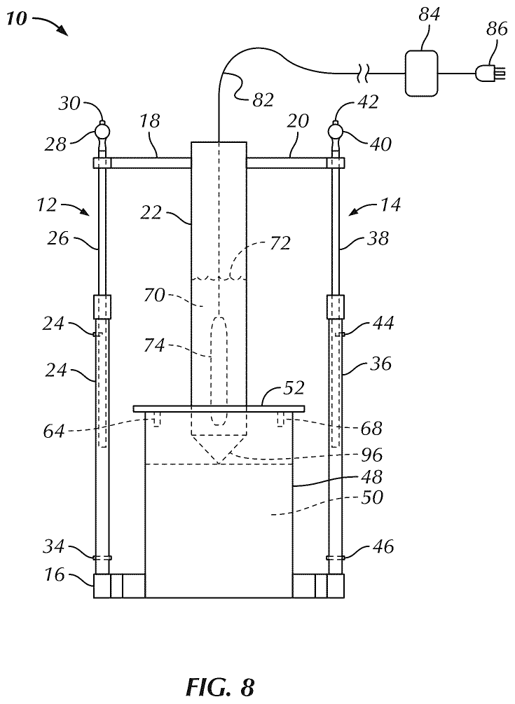

Next, the worker will lower the melting container 22 down through the opening 62 in the lid 52 until the bottom of the melting container 22 comes into contact with and rests on top of the upper surface of the hardened paraffin wax 50 inside the bulk container 48, as shown for example in FIG. 8. The worker does this by grasping the left handle 28 and the right handle 40, and then depressing the left button 30 and the right button 42. This disengages the left release pin 32 and the right release pin 44, which disengages the left upper section 26 from the left lower section 24 so the left upper section 26 can be lowered in telescoping fashion down inside the left lower section 24, and disengages the right upper section 38 from the right lower section 36 so the right upper section 38 can be lowered in telescoping fashion down inside the right lower section 36. As this happens, the melting container 22 is being lowered at the same time, until the bottom of the melting container comes into contact with the upper surface of the hardened paraffin wax 50.

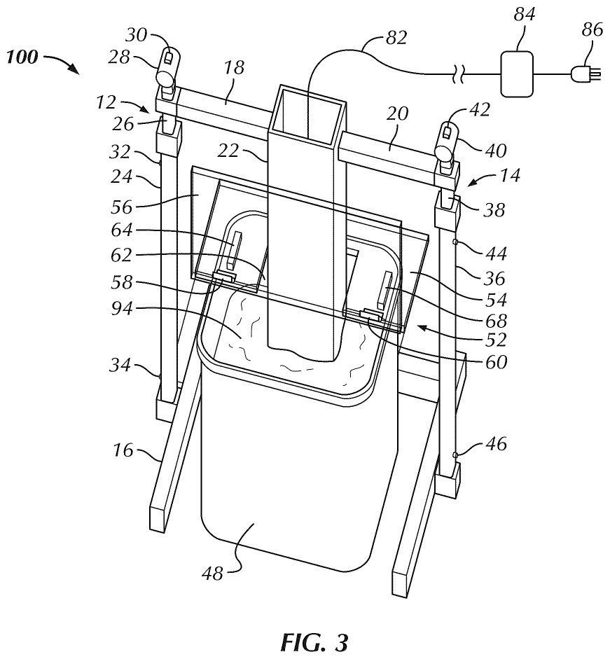

As the water heats up inside the melting container 22, heat will be transferred from the water 70 through the melting container 22 to the hardened paraffin wax 50, which will cause the paraffin wax 50 to melt. As the paraffin wax 50 melts, the melting container 22 will gradually sink or lower downwardly inside the bulk container 48 and into the melted paraffin wax 94, as shown for example in FIGS. 3 and 9. As mentioned above, in a specific embodiment, the melting container 22 will stop and be preventing from moving downwardly any further when the lower end of the left upper section 26 comes into contact with the left lower stop pin 34 and the lower end of the right upper section 38 comes into contact with the right lower stop pin 46. In a specific embodiment, when in this lowermost position, the lower surface of the melting container 22 is spaced apart a relatively short distance (e.g., 12 inch, ¾ inch, 1 inch, etc.) from and above the interior bottom surface of the bulk container 48.

As the hardened paraffin wax 50 starts melting, the salon worker can open the front door 56 on the lid 52 (assuming the lid 52 is being used) and dip out melted paraffin wax 94 for use. Once all of the paraffin wax 50 inside the bulk container 48 has been melted and removed for use, the worker can grasp the left handle 28 and the right handle 40, and pull the handles and the melting container 22 upwardly until the left release pin 32 and the right release pin 44 engages and locks the melting container 22 in its upper, locked position, such as shown in FIGS. 1 and 7. At this point, the empty bulk container 48 can be removed and a new bulk container 48 filled with hardened paraffin wax can be inserted below the melting container 22 and the process may be repeated as explained above.

The present inventions provide numerous advantages over the current state of the art. Use of the present inventions results in making more melted wax available for use in a shorter amount of time. For example, testing has shown that, during a 45-minute test period, about 30 pounds of hardened paraffin wax can be melted and available for use, whereas using the existing method described above only about with the present inventions, about 30 pounds of hardened paraffin wax can be melted. Using the present inventions is more efficient and results in greater volumes of melted wax available for use in less time and with less work. This allows salons to more quickly and more efficiently serve more customers. Use of the present inventions also results in cost savings to beauty salons. Paraffin wax can be sold in bulk at prices that are far less than current paraffin wax prices for one-pound packages. Using the present inventions also reduces costs in terms of labor and handling.

It is to be understood that the inventions disclosed herein are not limited to the exact details of construction, operation, exact materials, or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. It should also be understood that relative terms such as “upper” and “lower” and “upwardly” and “downwardly” are simply to provide frame of reference and should not be taken as limiting to any particular orientation. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A wax melting apparatus comprising:
a lower support base;
a left vertical support connected to the lower support base and extending upwardly therefrom;
a right vertical support connected to the lower support base and extending upwardly therefrom;
a melting container connected between the left vertical support and the right vertical support, the melting container being movable between an upper locked position and a lowermost position; and
a heating element positioned within the melting container.

2. The wax melting apparatus of claim 1, wherein each of the left vertical support and the right vertical support has an upper locked position corresponding to the upper locked position of the melting container and a lowermost position corresponding to the lowermost position of the melting container.

3. The wax melting apparatus of claim 2, wherein:
the left vertical support includes a left lower section and a left upper section, the left upper section being disposed for releasable slidable movement within the left lower section; and
the right vertical support includes a right lower section and a right upper section, the right upper section being disposed for releasable slidable movement within the right lower section.

4. The wax melting apparatus of claim 3, wherein:
the left vertical support further includes a left handle having a left release button; and
the right vertical support further includes a right handle having a right release button.

5. The wax melting apparatus of claim 4, wherein:
the left release button has a locked position and a depressed position, the left upper section being locked to the left lower section when the left release button is in its locked position, and the left upper section being free to move within the left lower section when the left release button is in its depressed position; and
the right release button has a locked position and a depressed position, the right upper section being locked to the right lower section when the right release button is in its locked position, and the right upper section being free to move within the right lower section when the right release button is in its depressed position.

6. The wax melting apparatus of claim 5, wherein:
an upper end of the left lower section includes a left release pin adapted for releasable engagement with a lower end of the left upper section, the left release pin being adapted to release engagement between the left upper section and the left lower section in response to movement of the left release button from its locked position to its depressed position; and
an upper end of the right lower section includes a right release pin adapted for releasable engagement with a lower end of the right upper section, the right release pin being adapted to release engagement between the right upper section and the right lower section in response to movement of the right release button from its locked position to its depressed position.

7. The wax melting apparatus of claim 3, wherein:
a lower end of the left lower section included a left lower stop pin, and a lower end of the left upper section being engaged with the left lower stop pin when the left vertical support is in its lowermost position; and
a lower end of the right lower section included a right lower stop pin, and a lower end of the right upper section being engaged with the right lower stop pin when the right vertical support is in its lowermost position.

8. The wax melting apparatus of claim 1, further including a bulk container containing hardened wax positioned between the left vertical support and the right vertical support and beneath the melting container when the melting container is in it upper locked position, the lower end of the melting container resting on an upper surface of the hardened wax in the bulk container after the melting container is released from its upper locked position.

9. The wax melting apparatus of claim 8, further including a lid engaged with an upper end of the bulk container, the lid having an opening, the melting container being positioned through the opening when the melting container is resting on the upper surface of the hardened wax.

10. The wax melting apparatus of claim 1, wherein a shape of a lower end of the melting container is one of a pyramid, a flat end, and a triangular prism.

11. A wax melting apparatus comprising:
a lower support base;
a left vertical support connected to the lower support base and extending upwardly therefrom, the left vertical support including a left lower section and a left upper section, the left upper section being disposed for releasable slidable movement within the left lower section, the left upper section having an upper locked position and a lowermost position;
a right vertical support connected to the lower support base and extending upwardly therefrom, the right vertical support including a right lower section and a right upper section, the right upper section being disposed for releasable slidable movement within the right lower section, the right upper section having an upper locked position and a lowermost position;
a melting container connected between the left vertical support and the right vertical support, the melting container being movable between an upper locked position and a lowermost position, the upper locked position of the melting container corresponding to the upper locked position of the left upper section and to the upper locked position of the right upper section, the lowermost position of the melting container corresponding to the lowermost position of the left upper section and to the lowermost position of the right upper section; and
a heating element positioned within the melting container.

12. The wax melting apparatus of claim 11, wherein:
the left vertical support further includes a left handle having a left release button, the left release button having a locked position and a depressed position, the left upper section being locked to the left lower section when the left release button is in its locked position, and the left upper section being free to move within the left lower section when the left release button is in its depressed position; and
the right vertical support further includes a right handle having a right release button, the right release button having a locked position and a depressed position, the right upper section being locked to the right lower section when the right release button is in its locked position, and the right upper section being free to move within the right lower section when the right release button is in its depressed position.

13. The wax melting apparatus of claim 12, wherein:
an upper end of the left lower section includes a left release pin adapted for releasable engagement with a lower end of the left upper section, the left release pin being adapted to release engagement between the left upper section and the left lower section in response to movement of the left release button from its locked position to its depressed position; and
an upper end of the right lower section includes a right release pin adapted for releasable engagement with a lower end of the right upper section, the right release pin being adapted to release engagement between the right upper section and the right lower section in response to movement of the right release button from its locked position to its depressed position.

14. The wax melting apparatus of claim 11, wherein:
a lower end of the left lower section included a left lower stop pin, and a lower end of the left upper section being engaged with the left lower stop pin when the left vertical support is in its lowermost position; and
a lower end of the right lower section included a right lower stop pin, and a lower end of the right upper section being engaged with the right lower stop pin when the right vertical support is in its lowermost position.

15. The wax melting apparatus of claim 11, further including a bulk container containing hardened wax positioned between the left vertical support and the right vertical support and beneath the melting container when the melting container is in it upper locked position, the lower end of the melting container resting on an upper surface of the hardened wax in the bulk container after the melting container is released from its upper locked position.

16. The wax melting apparatus of claim 15, further including a lid engaged with an upper end of the bulk container, the lid having an opening, the melting container being positioned through the opening when the melting container is resting on the upper surface of the hardened wax.

17. A method of removing hardened wax from a container comprising:
providing a melting container;
partially filling the melting container with a liquid;
positioning the melting container above a bulk container of hardened wax;
heating the liquid; and
lowering the melting container until a lower end of the melting container contacts an upper surface of the hardened paraffin wax.

18. The method of claim 17, further including:
allowing the melting container to lower down into the bulk container as the wax is melted.

19. The method of claim 18, further including:
stopping the container before it comes into contact with a lower surface of the bulk container.

20. The method of claim 17, further including energizing a heater submerged in the liquid inside the melting container to heat the liquid.
